(19) United States
(12) Patent Application Publication
(10) Pub. No.: US 2009/0198736 A1
(43) Pub. Date: Aug. 6, 2009

(54) Time-Based Multiple Data Partitioning

(76) Inventors: Jinmei Shen, Rochester, MN (US); Hao Wang, Rochester, MN (US)

Correspondence Address: IBM CORPORATION, 3605 HIGHWAY 52 NORTH, DEPT. 917, BUILDING 006-1, ROCHESTER, MN, 55901-7829, US

(21) Appl. No.: 12/023,174

(22) Filed: Jan. 31, 2008

(51) Int. Cl. G06F 17/30

(52) U.S. Cl. 707/200; 707/E17.001

(57) ABSTRACT

A method, computer program product and computer system for dynamic data partitioning in a database system, which partitions data in a database system using at least one time-base data-partitioning scheme, maintains multiple time and data partitioning schemes, and utilizes database operations that work with partitions from time-based multiple data-partitioning schemes.

### BACKGROUND

1. Technical Field

The present invention relates to data partitioning optimization. More specifically, it relates to a method and system for allowing time-based multiple data partitioning in a database system.

2. Background Information

Many database systems utilize partitioned databases to store data because using these databases can greatly improve performance, reduce contention and increase availability of data. A partitioned database is made up of two or more database partitions, each of which includes its own data, indices, configuration files and transaction logs. A table in a database system can be stored distributedly in these database partitions, where some of the rows of the table may be stored in one partition, and other rows may be in other partitions. Database operation requests are decomposed automatically and executed in parallel among the applicable database partitions. The fact that databases are split across database partitions thus becomes transparent to users.

Data partitioning is the process that divides a database into partitioned databases. It divides a large database or a data file containing a large amount of data into multiple small and easily manageable databases or files, each maintained on a database partition. The partitioning can be done by either building separate smaller databases (each with its own tables, indices, and transaction logs), or by splitting selected elements, e.g. a table. The typical data-partitioning scheme involves partitioning through partitioning keys that are dependent on the user's data. This takes a partitioning key and assigns a partition based on certain criteria. Common criteria include (1) range partitioning, which selects a partition by determining if the partitioning key is inside a certain range; (2) list partitioning, in which a partition is assigned a list of values, and the partition is chosen if the partitioning key has one of these values; (3) hash partitioning, in which the value of a hash function determines membership in a partition; and (4) composite partitioning which allows for certain combinations of the above partitioning schemes, by, for example, first applying a range partitioning and then a hash partitioning. Other criteria can also be applied.

Data partitioning enables and enhances scalability and performance of a database system by accommodating a large amount of data that cannot be hosted in a single machine. Typically a data partitioning technique supports only one partitioning scheme. However, in a large database system, it is usually hard to determine beforehand how much data each partition will have and how many requests each partition will receive. If one partition grows over its size limit or receives too many requests, expensive and hazardous operations, e.g. moving whole over-sized partition or data re-organization, must be performed to prevent the database system from failing.

### SUMMARY

A method, computer program product and computer system for dynamic data partitioning in a database system, which partitions data in a database system using at least one time-base data-partitioning scheme, maintains multiple time and data partitioning schemes, and utilizes database operations that work with partitions from time-based multiple data partitioning schemes. This invention makes it possible to change partitioning schemes dynamically with time as real-time needs evolve, and to maintain all different partitions of time-based partitioning schemes.

### BRIEF DESCRIPTION OF DRAWINGS

FIG. 1 is a block diagram of three major components of one embodiment of the present invention.

FIG. 2 is a block diagram that illustrates an embodiment of the present invention in a three-tier client-middleware-server architecture.

FIG. 3 is a conceptual diagram of a computer system that can utilize the present invention.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Data partitioning is widely used to enhance scalability and performance of a large database system. The data partitioning method of a database system usually only supports one partitioning scheme. Hence, the sizes of the partitions are determined beforehand, regardless of the actual workload of the system. However, database operations are usually dynamic in a database system. Data in each partition may grow unevenly, and different partitions may receive uneven numbers of requests. Many problems can result from a single data partition scheme that cannot accommodate uneven data and uneven requests. In a database system that uses a single partitioning scheme, some partitions may become too busy (i.e. an overloading problem), while some others may receive a few requests or none (i.e. an under-loading problem); some partitions may have so much data that are over their capacities, while others may have only very few data.

The present invention proposes a method and system for data partitioning using time-based data-partitioning schemes. Time-base data-partitioning schemes use different time-intervals to divide the database into small database partitions of different sizes, where the time intervals are chosen to meet the needs of the users and the requirements of the workloads. The present invention thus enables the coexistence of multiple data partitioning schemes, and lets the database system use different data partition schemes dynamically. This invention resolves the problems associated with traditional data partition methods and avoids unnecessary system downtimes, big data moving or data re-organization.

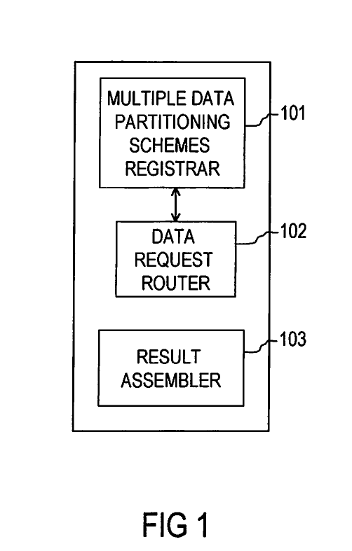

FIG. 1 shows a block diagram of three major components of one embodiment of the present invention. A Multiple Data Partitioning Schemes Registrar (MDPSR) 101 maintains the records of time, time intervals and data partitioning schemes for all partitioned database servers. A data request router 102, using the partitioning information recorded in MDPSR 101, routes database operation requests to various time-based partitions, and a result assembler 103 combines results from different time-based partitions, assembles them and sends the user a single result dataset.

Database operation requests from a user typically include insert, update, delete and query. When new data is inserted, the data request router 102 routes the request to the partition location that is directed to by the newest data partitioning. When the existing data is updated, the data request router 102 routes the request to all partitions, from the partition according to the newest data partitioning scheme to the one according to the oldest data partitioning scheme, until the data item is found; this data item is inserted into the partition location according to the newest partition scheme, and the corresponding data item in the partition according to the old data-partitioning scheme is then deleted. When a data item is deleted, the data request router 102 routes the request to all partitions, from the partition according to the newest data partitioning scheme to the one according to the oldest data partitioning scheme, until the data item is found, and then deletes this data item. When querying data, all partitions from all data partitioning schemes are scanned to get results using data request router 102, then the result assembler 103 combines data retrieved from all appropriate partitions and sends them back to the client. Whenever old partitions have empty data, the old partitions are deleted. Whenever all partitions that correspond to an old time-based partitioning scheme are deleted, that old time-based partitioning scheme is deleted.

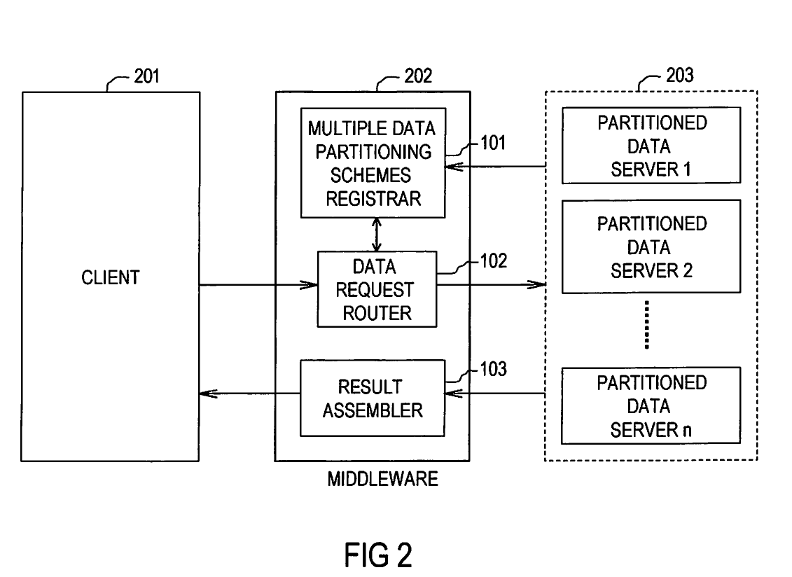

FIG. 2 is a block diagram that illustrates an embodiment of the present invention in a three-tier client-middleware-server architecture. A user sends database operation request from the front end—the client 201; the backend is composed of servers 203 with partitioned databases; and in between is the middleware 202 where the present invention may be implemented. The partitioned data severs 203 contain n partitioned database servers, which may reside at the same or different locations. The value of n and the size of each partition are determined by the requirements of users. Three components reside in the middleware 202: the MDPSR 101, the data request router 102, and the result assembler 103. The MDPSR 101 in the middleware 202 already records the time and the data-partitioning schemes for all of partitions that could be in different servers, at different locations, and of different sizes. When the user is sending this request to the main server, the data request router 102 on the middleware 202 routes this request to all partitions until all data are found from the partition that data reside. Appropriate database operations (e.g. insert, update, delete or query) are then performed. If a result will be returned to the user, such as in data querying, the result assembler 103 combines all data found from all appropriate partitions and then sends them back to the client. If the client wants the returned data in a certain order, the result assembler will process the data according to the user's requirements, then the ordered data will be returned to the client.

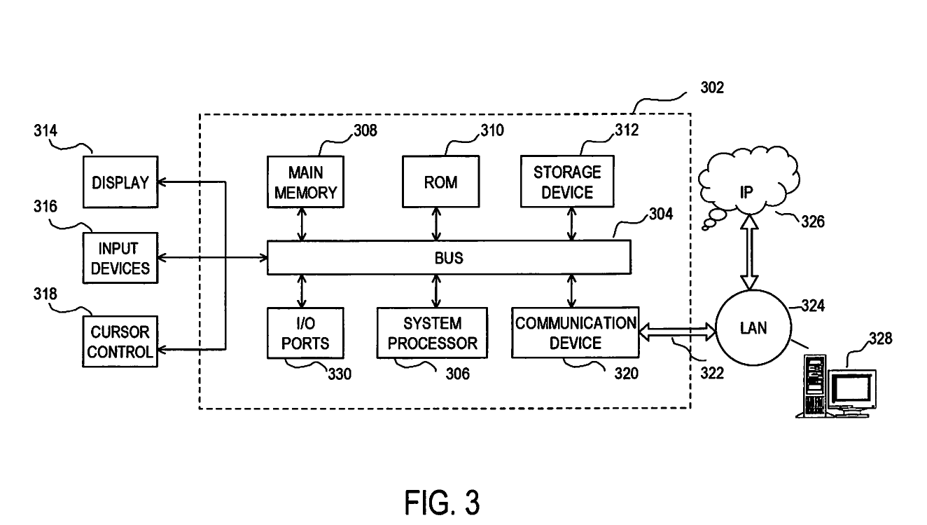

FIG. 3 illustrates a computer system (302) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (304) or other communication mechanism for communicating information and a processor (306) coupled with bus (304) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (306). In addition, main memory (308) may be used for storing temporary variables or other intermediate information during execution of instructions to be executed by processor. The computer system further includes a read only memory (ROM) 310 or other static storage device (e.g., programmable ROM (PROM), erasable PROM (EPROM), and electrically erasable PROM (EEPROM)) coupled to bus 304 for storing static information and instructions for processor. A storage device (312), such as a magnetic disk or optical disk, is provided and coupled to bus for storing information and instructions. This storage device is an example of a computer readable medium.

The computer system also includes input/output ports (330) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIG. 1. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct 15 memory access (DMA) bus). The computer system may additionally include a compact disc reader, a compact disc reader-writer unit, or a compact disc jukebox, each of which may be connected to the same device bus or another device bus.

The computer system may be coupled via bus to a display (314), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (316) and a cursor control (318), for communicating information and command selections to processor (306). Such command selections can be implemented via voice recognition hardware and/or software functioning as the input devices (316). The cursor control (318), for example, is a mouse, a trackball, cursor direction keys, touch screen display, optical character recognition hardware and/or software, etc., for communicating direction information and command selections to processor (306) and for controlling cursor movement on the display (314). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (320) provides a two-way data communication coupling to a network link (322) that may be connected to, for example, a local network (324). For example, the communication interface (320) may be a network interface card to attach to any packet switched local area network (LAN). As another example, the communication interface (320) may be an asymmetrical digital subscriber line (ADSL) card, an integrated services digital network (ISDN) card or a modem to provide a data communication connection to a corresponding type of telephone line. Wireless links may also be implemented via the communication interface (320). In any such implementation, the communication interface (320) sends and receives electrical, electromagnetic or optical signals that carry digital data streams representing various types of information.

Network link (322) typically provides data communication through one or more networks to other data devices. For example, the network link may provide a connection to a computer (326) through local network (324) (e.g., a LAN) or through equipment operated by a service provider, which provides communication services through a communications network (328). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A method for dynamic data partitioning in a database system, comprising:
partitioning data in the database system into a plurality of data partitions using at least one time-based data-partitioning scheme;
maintaining the at least one time-based data partitioning scheme; and
enabling at least one database operation that is operatively coupled with the at least one time-based data-partitioning scheme in the database system.

2. The method of claim 1, wherein the partitioning comprises using at least one time interval to divide the database into a plurality of data partitions, wherein each time interval is determined by each one of the at least one time-based data-partitioning schemes.

3. The method of claim 1, wherein the maintaining comprises recording time, time intervals and the at least one time-based data partitioning scheme for all data partitions in the database system.

4. The method of claim 1, wherein the maintaining comprises deleting a data partition if the data partition is empty, and deleting a time-based partitioning scheme if all data partitions corresponding to the time-based partitioning scheme are deleted.

5. The method of claim 1, wherein the at least one database operation comprises at least one of an insert, update, delete and query operation.

6. The method of claim 1, wherein the at least one database operation comprises a query operation that uses a result assembler to combine data retrieved from data partitions.

7. The method of claim 1, wherein the enabling comprises using a data request router to route a database operation request to at least one data partition where correct data for the database operation request is located.

8. A computer program product for dynamic data partitioning in a database system, the computer program product comprising:
a computer usable medium having computer usable program code embodied therewith, the computer usable program code comprising:
instructions to partition data in the database system into a plurality of data partitions using at least one time-based data-partitioning scheme;
instructions to maintain the at least one time-based data partitioning scheme; and
instructions to enable at least one database operation that is operatively coupled with the at least one time-based data-partitioning scheme in the database system.

9. The computer program product of claim 8, wherein the instructions to partition comprises instructions to use at least one time interval to divide the database into a plurality of data partitions, wherein each time interval is determined by each one of the at least one time-based data-partitioning schemes.

10. The computer program product of claim 8, wherein the instructions to maintain comprises instructions to record time, time intervals and the at least one time-based data partitioning scheme for all data partitions in the database system.

11. The computer program product of claim 8, wherein the instructions to maintain comprises instructions to delete a data partition if the data partition is empty, and instructions to delete a time-based partitioning scheme if all data partitions corresponding to the time-based partitioning scheme are deleted.

12. The computer program product of claim 8, wherein the at least one database operation comprises at least one of an insert, update, delete and query operation.

13. The computer program product of claim 8, wherein the at least one database operation comprises a query operation that uses a result assembler to combine data retrieved from data partitions.

14. The computer program product of claim 8, wherein the instructions to enable comprises instructions to use a data request router to route a database operation request to at least one data partition where correct data for the database operation request is located.

15. A computer system comprising:
a processor;
a memory operatively coupled with the processor;
a storage device operatively coupled with the processor and the memory; and
a computer program product for dynamic data partitioning in a database system, the computer program product comprising:
a computer usable medium having computer usable program code embodied therewith, the computer usable program code comprising:
instructions to partition data in the database system into a plurality of data partitions using at least one time-based data-partitioning scheme;
instructions to maintain the at least one time-based data partitioning scheme; and
instructions to enable at least one database operation that is operatively coupled with the at least one time-based data-partitioning scheme in the database system.

16. The computer system of claim 15, wherein the instructions to partition comprises instructions to use at least one time interval to divide the database into a plurality of data partitions, wherein each time interval is determined by each one of the at least one time-based data-partitioning schemes.

17. The computer system of claim 15, wherein the instructions to maintain comprises instructions to record time, time intervals and the at least one time-based data partitioning scheme for all data partitions in the database system.

18. The computer system of claim 15, wherein the instructions to maintain comprises instructions to delete a data partition if the data partition is empty, and instructions to delete a time-based partitioning scheme if all data partitions corresponding to the time-based partitioning scheme are deleted.

19. The computer system of claim 15, wherein the at least one database operation comprises at least one of an insert, update, delete and query operation.

20. The computer system of claim 15, wherein the at least one database operation comprises a query operation that uses a result assembler to combine data retrieved from data partitions.

21. The computer system of claim 15, wherein the instructions to enable comprises instructions to use a data request router to route a database operation request to at least one data partition where correct data for the database operation request is located.
